(19) United States
(12) Patent Application Publication
(10) Pub. No.: US 2024/0227233 A1
(43) Pub. Date: Jul. 11, 2024

(54) APPARATUS AND METHOD FOR FINISHING A WORKPIECE

(71) Applicant: HOMAG GmbH, Schopfloch (DE)

(72) Inventors: Ludwig ALBRECHT, Dornstetten-Aach (DE); Peter WULZINGER, Sulz a. N. (DE)

(21) Appl. No.: 18/558,725

(22) PCT Filed: May 23, 2022
(86) PCT No.: PCT/EP2022/063868

§ 371 Date: Nov. 2, 2023

(30) Foreign Application Priority Data
May 27, 2021 (DE) 10 2021 113 681.4

(51) Int. Cl. B27M 1/08; B05C 9/12; B27M 1/00; B41J 2/045

(52) U.S. Cl. CPC B27M 1/08; B05C 9/12; B27M 1/003; B41J 2/04573; B41J 2/04593

(57) ABSTRACT

Method and apparatus (1) for finishing (2) a workpiece preferably consisting at least in parts of wood, wood materials, plastic or the like, comprising a machining unit (10) for machining the workpiece (2), in particular for shaping and/or coating the workpiece; a patterning unit (20) for patterning, in particular printing on, a surface (2′) of the workpiece; and a conveying unit (30) for inducing a relative movement between the workpiece and the machining unit (10) as well as the patterning unit (20), characterized in that a control unit (40) is provided, which is connected to the machining unit (10), the conveying unit (30) and the patterning unit (20) and is configured to control the machining unit (10), the conveying unit (30) and the patterning unit (20).

### TECHNICAL FIELD

The invention relates to an apparatus for finishing a workpiece preferably consisting at least in parts of wood, wood materials, plastic or the like, as according to the preamble of claim 1, as well as a corresponding method.

### PRIOR ART

In the furniture and components industry, workpieces are often first manufactured from a wood-based material and are then finished at their surface. During finishing, various coating materials are used which may already be patterned before the coating process or which may only be patterned after the coating process.

For example, EP 1 935 657 A1 discloses an apparatus of the same type and a method for coating workpieces, in which the workpieces are first machined and then patterned by means of an inkjet printing device. However, it has been shown that the performance of the known apparatus is limited and that there is considerable potential for improvement, in particular with regard to the workpiece throughput.

### DESCRIPTION OF THE INVENTION

It is the object of the present invention to provide an apparatus and a method of the type specified above, which allow an increased performance and in particular an increased workpiece throughput.

According to the invention, this object is solved by means of an apparatus for finishing a workpiece according to claim 1 and/or by mans of a method for finishing a workpiece according to claim 12. Distinct embodiments are derivable from the dependent claims.

The invention is based on the finding that in known apparatuses the operating parameters and the operating speed of the individual machine components are not sufficiently coordinated. To remedy this, the invention proposes that in an apparatus of the same type a control unit is provided, which is connected to the machining unit, the conveying unit and the patterning unit and is configured to control the machining unit, the conveying unit and the patterning unit.

This integration of control technology enables the operating parameters, the operating speed and other properties of the machine components to be optimally coordinated depending on the current requirements (such as workpiece dimensions, material properties, finishing requirements etc.) in order to increase, inter alia, the performance and, in particular, the workpiece throughput. In addition to these improvements, the integration of control technology also provides further advantages, such as the possibility of improved optical and haptic properties, since the machining and finishing operation of the machining unit and the patterning unit can also be optimally coordinated here.

In this context, it is significant that in known machines the patterning unit was often a limiting factor for the performance of the overall process, so that a possibly higher performance of, for example, a machining unit could not be exploited. The integration of control technology now makes it possible, for example by optimally adapting the operating parameters of the patterning unit, to increase the individual performance of the patterning unit and thus the overall performance of the apparatus or of the overall process.

In this respect, it is particularly preferred that the conveying unit is configured to induce a relative movement speed of at least 10 m/min, preferably at least 30 m/min, particularly preferably at least 50 m/min, during operation of the machining unit and the patterning unit. In this way, the apparatus according to the invention reaches performance ranges that could not be achieved before. On the one hand, productivity can therefore be increased immensely, and on the other hand, the apparatus according to the invention is thus also suitable for workpieces that are manufactured in extremely large numbers and at correspondingly high speeds, such as floor or wall panels.

According to a further development of the invention, it is provided that the conveying unit is configured to induce the relative movement between the workpiece and the machining unit as well as the patterning unit in a single clamping setup. On the one hand, a multiple alignment and clamping of the workpieces as well as possible intermediate stacking are thus not necessary. On the other hand, a particularly high precision of the finishing process with a correspondingly high workpiece quality is achieved. In addition, particularly high finishing speeds are made possible, which further contributes to increasing productivity.

The control unit is preferably configured to set at least one operating parameter of the patterning unit by taking into account a target conveying speed of the conveying unit. In this way, the operation of the patterning unit can be optimally adapted to the target conveying speed of the conveying unit, with the target conveying speed resulting from the maximum machining speed of the machining unit, for example. As a result, the conveying speed of the apparatus according to the invention can thus be maximized, which can significantly increase productivity. For this purpose, various operating parameters of the patterning unit can be set to the desired performance, such as a clock frequency, material throughput, etc.

It is particularly preferred that the control unit is configured to change, in particular to reduce, the target conveying speed of the conveying unit if the control unit cannot determine suitable operating parameters of the patterning unit for the previous target conveying speed. In this way, it is ensured, for example, that despite the maximum conveying speed the required quality of the patterning can still be achieved, while the maximum speed potential of the patterning unit is exploited.

Within the scope of the invention, the patterning unit can be configured in different ways. With regard to a high patterning quality, variable patterning possibilities and a high patterning speed, it is provided, according to a further development of the invention, that the patterning unit comprises a drop-on-demand printing unit. In this respect, it is particularly preferred that the drop-on-demand printing unit is configured to variably set the output droplet size and/or droplet output frequency. By setting these operating parameters, the operation of the patterning unit can be adapted particularly effectively to different conveying speeds without adversely affecting the quality of the patterning result. At the same time, further advantageous effects can also be achieved by setting the droplet size and/or the droplet output frequency, such as haptic effects of the patterned surface or the setting of different “shades of gray” (intensity levels dependent on the amount of color).

With regard to particularly high conveying speeds, it has proven to be advantageous if, according to a further development of the invention, the droplet size can be set to values smaller than 200 pl, preferably smaller than 100 pl, particularly preferably smaller than 20 pl (picoliter). For this purpose, it is alternatively or additionally also preferred that the droplet output frequency can be set to values of at least 16000 Hz, preferably 20000 Hz, particularly preferably 100000 Hz.

According to a further development of the invention, it is furthermore provided that the apparatus comprises a monitoring unit for monitoring, preferably optically, the surface of the workpiece patterned by the patterning unit. This makes it possible to effectively monitor whether the patterning unit actually provides the patterned surface with the desired patterning quality, which is particularly advantageous in the case of the desired high conveying speeds and which generally allows an optimization of the process. In this respect, it is particularly preferred that the monitoring unit is connected to the control unit, so that the results of the monitoring unit can directly be used to optimize the operation of the patterning unit.

With regard to a precise monitoring of the patterned surface, it is furthermore preferred that the monitoring unit comprises a camera, in particular a multispectral camera or a hyperspectral camera. In particular hyperspectral cameras have proven to be extremely effective.

With regard to an optimization of the patterning quality, it is provided, according to a further development of the invention, that the control unit is configured to correct at least one operating parameter of the patterning unit on the basis of the monitoring result of the monitoring unit, preferably during operation of the apparatus. In this way, it is possible to optimize the patterning quality particularly effectively and also to minimize rejects since the monitoring results can be fed back “inline”, if necessary, and used directly to optimize the operating parameters of the patterning unit.

The above advantages can be achieved in a particularly useful manner by a method according to claim 12.

### BRIEF DESCRIPTION OF THE DRAWING

FIG. 1 shows a schematic side view of an apparatus according to an embodiment of the invention.

### DESCRIPTION OF EMBODIMENTS

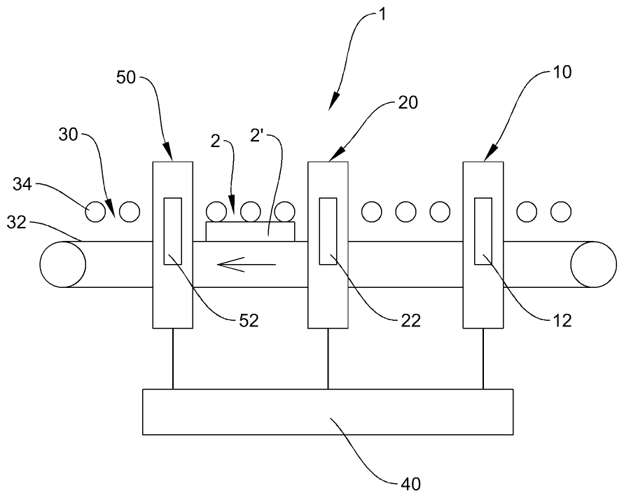

An apparatus 1 for finishing a workpiece 2 is shown schematically in a side view in FIG. 1. The workpiece can be, for example, a furniture panel, a floor/wall panel or a construction element such as a door, and the starting material of the workpiece can be, for example, wood, various wood materials, plastic and various combinations thereof. In the present case, the workpiece is to be finished in the area of a surface 2′, which can be a narrow surface of the workpiece 2, for example.

As can be seen from FIG. 1, the apparatus 1 first comprises a machining unit 10 which in the present embodiment is a milling unit that serves to bring the narrow surface 2′ of the workpiece 2 to be finished into the desired geometry. For this purpose, the machining unit 10 in the present embodiment comprises a milling tool 12. Alternatively or additionally, however, the machining unit 10 can also be configured for other machining processes such as applying a coating material or flush milling an applied coating material.

In addition, the apparatus 1 comprises a patterning unit 20 for patterning the surface 2′ of the workpiece, which in the present embodiment is a printing unit that will be described in more detail below.

Moreover, a conveying unit 30 is provided, which in the present embodiment is configured as a continuous conveying unit and which serves to move the respective workpiece 2 along the machining unit 10 and the patterning unit 20. It should be noted, however, that other conveying concepts can also be used within the scope of the invention, such as so-called stationary technology, in which the workpiece rests and the respective units of the apparatus are moved. Hybrid forms of both concepts are also possible within the scope of the invention.

In the present embodiment, the conveying unit 30 comprises a conveyor belt or a conveyor chain 32 onto which the respective workpiece 2 is placed, with the upper strand moving from right to left in FIG. 1. In addition, the conveying unit 30 has a so-called top pressure member 34 which, in the present embodiment, is formed by a plurality of rollers that press the respective workpiece 2 onto the conveyor belt or the conveyor chain 32.

As can be seen from FIG. 1, this results in a clamping of the workpiece 2, with the workpiece 2 being held in a defined clamping setup along the entire apparatus 1. The conveying unit 30 can be operated at different conveying speeds which can be in the range of up to 200 m/min and more.

As can be seen from FIG. 1, the machining unit 10, the patterning unit 20 and the conveying unit 30 are connected to a control unit 40 which serves to control the machining unit 10, the patterning unit 20 and the conveying unit 30. Within the scope of the present invention, the term “control” can mean mere control (without feedback) or feedback control (with feedback), as required.

The control unit can be, for example, a common machine computer in which the essential data of the above units come together and which controls the above units, i.e. in particular sets their operating parameters.

In the present embodiment, the control unit 40 first sets a target conveying speed of the conveying unit 30, which is based on the machining speed of the machining unit 10 that can be achieved for the respective workpiece 2, taking into account the geometry and the material properties, for example. After that, the control unit 40 sets one or more operating parameters of the patterning unit 20 such that the patterning unit 20 can also operate properly at the given target conveying speed, so that a desired patterning result can be achieved.

In certain constellations, such as very high target conveying speeds or particularly complex patterning tasks, it may not be possible to set suitable operating parameters for the patterning unit 20 that ensure the desired patterning quality. In this case, the control unit 40 reduces the target conveying speed of the conveying unit 30 to a value at which proper operation of the patterning unit 20 is possible, but the highest possible conveying speed of the conveying unit 30 can still be achieved.

In the present embodiment, the patterning unit 20 is a printing apparatus comprising a drop-on-demand printing unit 22, although other patterning units can, of course, also be used within the scope of the present invention. The drop-on-demand printing unit 22 can include a piezo print head or a bubble jet print head, for example.

The printing unit 22 is able to variably set the output droplet size, with the droplet size being able to reach values of up to 2 pl (picoliter) in the present embodiment. Depending on the case of use, however, larger values are also useful, which can advantageously be in the range of up to 200 pl, without the invention being restricted thereto. On the one hand, setting the droplet size allows the patterning unit 20 to be adapted to different conveying speeds; on the other hand, it also allows haptic effects to be achieved as well as different color effects such as “shades of gray” (intensity levels dependent on the amount of color).

In addition, the printing unit 22 is also able to set, for example, the droplet output frequency to values on the order of, for example, 20000 Hz or even 100000 Hz or more as well as other operating parameters. The droplet output frequency can be set using software, for example, in particular also by defining different pulse shapes which are applied, for example, to piezo elements provided in the printing unit 22.

Downstream of the patterning unit 20, the apparatus 1 further comprises a monitoring unit 50 which, in the present embodiment, comprises a multispectral camera or a hyperspectral camera 52. The camera 52 scans the patterned surface 2′ of the workpiece 2. The monitoring unit 50 is also connected to the control unit 40, so that a monitoring result of the monitoring unit 50 can be transmitted to the control unit 40.

On the basis of the monitoring result of the monitoring unit 50, the control unit 40 corrects one or more operating parameters of the patterning unit 20 in order to further optimize the quality of the patterning result or to come closer to a desired target value. This correction can also take place on the basis of a statistical evaluation, for example, and can be carried out “inline”, i.e. during operation of the apparatus.

The apparatus 1 is operated as follows, for example. First, a workpiece 2 is supplied to the apparatus 1 such that it is clamped between the conveyor belt or the conveyor chain 32 and the top pressure member 34 (right in FIG. 1) and conveyed in a continuous conveying direction (from right to left in FIG. 1). Taking into account the properties of the workpiece and the desired finishing processes, the control unit 40 first determines a target conveying speed suitable for the machining unit 10 and then sets the operating parameters of the patterning unit 20 in a suitable manner. If necessary, the conveying speed can also be reduced, as described above. Moreover, it should be noted that the conveying speed does not necessarily have to be adapted for each individual workpiece 2 and that the apparatus 1 can also operate for different workpieces 2 within a certain permissible range of the conveying speed and the operating parameters.

After that, the workpiece 2 reaches the machining unit 10 and is machined there in the area of its narrow surface 2′ by means of the machining tool 12. In the next step, the machined narrow surface 2′ is patterned by means of the patterning unit 20, and then the monitoring unit 50 monitors the patterned surface 2′. The monitoring result of the monitoring unit 50 is transmitted to the control unit 40 which adapts the operating parameters of the patterning unit 20 if there are any defined deviations of the monitoring result from the desired patterning. In certain cases, deviations may also require an adaptation of the machining unit 10 (for example to a different rotational speed of the tool) or of the conveying unit 30 (for example to a different conveying speed) if these parameters may adversely affect the quality of the patterning result in the respective case.

1. An apparatus for finishing a workpiece, comprising:
a machining unit for machining the workpiece, in particular for;
a patterning unit for patterning a surface of the workpiece;
a conveying unit for inducing a relative movement between the workpiece and the machining unit as well as the patterning unit; and
a control unit that is connected to the machining unit, the patterning unit and the conveying unit and is configured to control the machining unit, the patterning unit and the conveying unit.

2. The apparatus according to claim 1, wherein the conveying unit is configured to induce a relative movement speed of at least 10 m/min during operation of the machining unit and the patterning unit.

3. The apparatus according to claim 1, wherein the conveying unit is configured to induce the relative movement between the workpiece and the machining unit as well as the patterning unit in a single clamping setup.

4. The apparatus according to claim 1, wherein the control unit is configured to set at least one operating parameter of the patterning unit by taking into account a target conveying speed of the conveying unit.

5. The apparatus according to claim 4, wherein the control unit is configured to change the target conveying speed of the conveying unit if the control unit cannot determine suitable operating parameters of the patterning unit.

6. The apparatus according to claim 1, wherein the patterning unit comprises a drop-on-demand printing unit configured to variably set an output droplet size or droplet output frequency.

7. The apparatus according to claim 6, wherein the output droplet size can be set to values smaller than 200 pl.

8. The apparatus according to claim 6, wherein the droplet output frequency can be set to values of at least 16000 Hz.

9. The apparatus according to claim 1, wherein a monitoring unit is provided for monitoring the surface of the workpiece patterned by the patterning unit, the monitoring unit being connected to the control unit.

10. The apparatus according to claim 9, wherein the monitoring unit comprises a camera (52).

11. The apparatus according to claim 9, wherein the control unit is configured to correct at least one operating parameter of the patterning unit based on the monitoring result of the monitoring unit.

12. A method for finishing a workpiece using an apparatus according to claim 1, the apparatus comprising a machining unit, a patterning unit, a conveying unit, and a control unit, the method comprising the steps of:
inducing a relative movement between the workpiece and the machining unit and the patterning unit via the conveying unit;
machining the workpiece by means of the machining unit; and
patterning a surface of the workpiece by means of the patterning unit, wherein
the control unit controls the machining unit, the conveying unit and the patterning unit during the method for finishing.

13. The apparatus according to claim 10, wherein the camera comprises a multispectral camera or a hyperspectral camera.
